(19) United States
(12) Patent Application Publication
(10) Pub. No.: US 2018/0089708 A1
(43) Pub. Date: Mar. 29, 2018

(54) SHARING COUPONS BASED ON USER DEVICE LOCATION

(71) Applicant: INTERNATIONAL BUSINESS MACHINES CORPORATION, Armonk, NY (US)

(72) Inventors: Jeremy A. Greenberger, Raleigh, NC (US); Jana H. Jenkins, Raleigh, NC (US)

(21) Appl. No.: 15/275,909

(22) Filed: Sep. 26, 2016

(51) Int. Cl. G06Q 30/02; H04W 4/02; H04L 29/08

(52) U.S. Cl. CPC G06Q 30/0223; H04L 67/10; G06Q 30/0239; H04W 4/021

(57) ABSTRACT

A computer-implemented method includes: monitoring, by a computing device, a location of a user device; detecting, by the computing device, the availability of an electronic coupon stored in an inventory based on the location of the user device and a location associated with the electronic coupon; offering, by the computing device, the electronic coupon to the user device based on the detecting the availability by providing an electronic query to the user device for display on the user device; assigning, by the computing device, the electronic coupon to the user device based on the offering the electronic coupon to the user device; detecting, by the computing device, that the user device departs a boundary based on the monitoring the location; and assigning, by the computing device, an unused portion of the electronic coupon to the inventory based on the detecting that the user device departs the boundary.

### BACKGROUND

The present invention generally relates to sharing electronic coupons and, more particularly, to sharing electronic coupons within a venue based on user device location.

Electronic coupons may be accessible via user devices (e.g., smartphones, tablets, etc.) and may provide discounts off of merchandise offered by a merchant. For example, electronic coupons may include bar codes, quick response (QR) codes, alphanumerical codes, or the like that can be displayed on a user device and scanned by the merchant's checkout system.

### SUMMARY

In an aspect of the invention, a computer-implemented method includes: monitoring, by a computing device, a location of a user device by communicating with one or more location determination devices that are used to determine the location of the user device through computing network communications with the user device; detecting, by the computing device, the availability of an electronic coupon stored in an inventory based on the location of the user device and a location associated with the electronic coupon; offering, by the computing device, the electronic coupon to the user device based on the detecting the availability by providing an electronic query to the user device for display on the user device; assigning, by the computing device, the electronic coupon to the user device based on the offering the electronic coupon to the user device; detecting, by the computing device, that the user device departs a boundary based on the monitoring the location; and assigning, by the computing device, an unused portion of the electronic coupon to the inventory based on the detecting that the user device departs the boundary.

In aspect of the invention, there is a computer program product for sharing unused or partially used electronic coupons when a user departs a facility. The computer program product comprises a computer readable storage medium having program instructions embodied therewith, the program instructions executable by a computing device to cause the computing device to: monitor a location of a user device while the user device is located within the facility, wherein the monitoring includes communicating with one or more location determination devices that are used to determine the location of the user device through computing network communications with the user device; detect the availability of an electronic coupon stored in an inventory based on the location of the user device and a location associated with the electronic coupon; offer the electronic coupon to the user device based on the detecting the availability by providing an electronic query to the user device for display on the user device; assign the electronic coupon to the user device based on the offering the electronic coupon to the user device; detect that the user device departs the facility based on the monitoring the location; and assign an unused portion of the electronic coupon to the inventory based on the detecting that the user device departs the boundary.

In an aspect of the invention, a system comprises: a CPU, a computer readable memory and a computer readable storage medium associated with a computing device; program instructions to monitor a location of a user device while the user device is located within the facility, wherein the monitoring includes communicating with one or more location determination devices that are used to determine the location of the user device through computing network communications with the user device; program instructions to assign an electronic coupon to the user device; program instructions to track a usage of the electronic coupon based on assigning the electronic coupon; program instructions to determine that the user device has departed the facility based on the monitoring the location of the user device; program instructions to reassign the electronic coupon to another user device based on determining that the user device has departed the facility. The program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an overview of an example implementation in accordance with aspects of the present invention

FIG. 5 shows an example environment in accordance with aspects of the present invention.

FIG. 6 shows a block diagram of example components of a coupon management server in accordance with aspects of the present invention

FIG. 7 shows an example flowchart for offering an available coupon to a user and sharing unused portions of the coupon to other users in accordance with aspects of the present invention.

### DETAILED DESCRIPTION

The present invention generally relates to sharing electronic coupons and, more particularly, to sharing electronic coupons within a venue based on user device location. Merchants may offer electronic coupons (also referred to herein simply as “coupons”) to potential shoppers in order to increase sales and/or improve shopper relations. Some coupons may offer a discount based on the purchase of multiple items (e.g., buy three items to save 75 cents). Such coupons may be offered to encourage shoppers to purchase additional items, thereby improving sales (e.g., a “multiple item coupon”). However, often times, a shopper may not want or need multiple items, but may still wish to take advantage of the savings offered by the coupon. Accordingly, aspects of the present invention may allow a user (e.g., a shopper) to share multiple item coupons with other users. In the above example, a user may purchase a single item, receive a pro-rated discount off the single item, and offer the remaining discount to other shoppers upon the user's exit of a merchant facility. In this way, multiple users may share a single coupon when a single user is unable to purchase multiple items to redeem a multiple item coupon in its entirety. As further described herein, a single item coupon may also be shared with another user if the original user did not use the coupon upon leaving the merchant facility. Additionally, or alternatively, different coupons may be offered to users based on the location of the users within the merchant facility (e.g., coupons for cereal may be offered when a user is located in a cereal aisle)

As described herein, aspects of the present invention may include a coupon management server that may track the chain of custody of a coupon. For example, the coupon management server may track information identifying a user device associated with a shopper to which the coupon is currently assigned or if the coupon is assigned to the store inventory (e.g., not currently assigned to a user device). Further, the coupon management server may also track the coupon's value. For example, the coupon's value may change each time a portion of the coupon is redeemed (e.g., the coupon's value may reduce 25 cents when one out of three items are purchased and when the original value of the coupon was 75 cents). Additionally, or alternatively, the coupon management server may track the coupon's status (e.g., the number of items bought in connection with the coupon). For example, if the coupon offers a 75 cent discount upon the purchase of 3 items, and only 1 item has been purchased, the coupon management server may track that the coupon has 2 remaining purchases to be made before the discount is disbursed. Once all items have been purchased in connection with the coupon, the discounted amount can be disbursed to the purchasers on a pro-rata basis.

Aspects of the present invention may reduce the consumption of computing resources on a coupon management system by reducing the total number of coupons issued and tracked in relation to when an entire catalog of coupons is provided to a user. Also, by reducing consumption of computing resources, aspects of the present invention may increase the number of users that can be accommodated or offered coupons for use. That is, aspects of the present invention may increase system capacity for offering coupons. Further, sharing of coupons may positively impact the consumption of computing resources on user devices since unused coupons are removed from storage on the user devices. In this way, the operations of a coupon management system and of user devices are improved as a result of more efficient computer resource usage.

While aspects of the present invention may track the location of user devices, location tracking may occur on an “opt-in” basis in which a user provides explicit permission for location to be tracked within a merchant facility. Further, location tracking may be implemented in accordance with applicable privacy laws and may be discontinued at any time for users who have revoked permission for location tracking.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

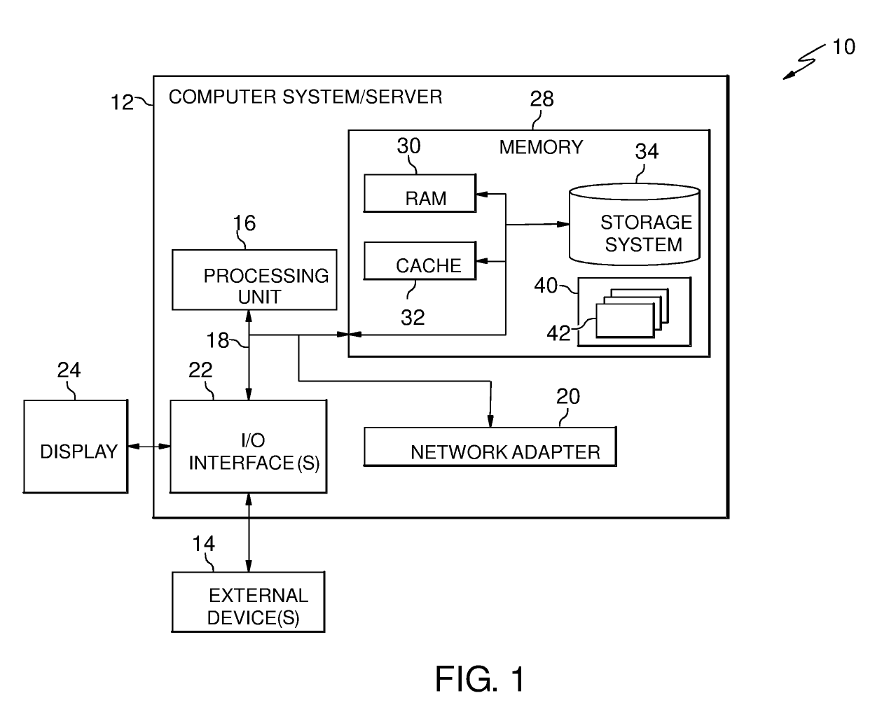

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

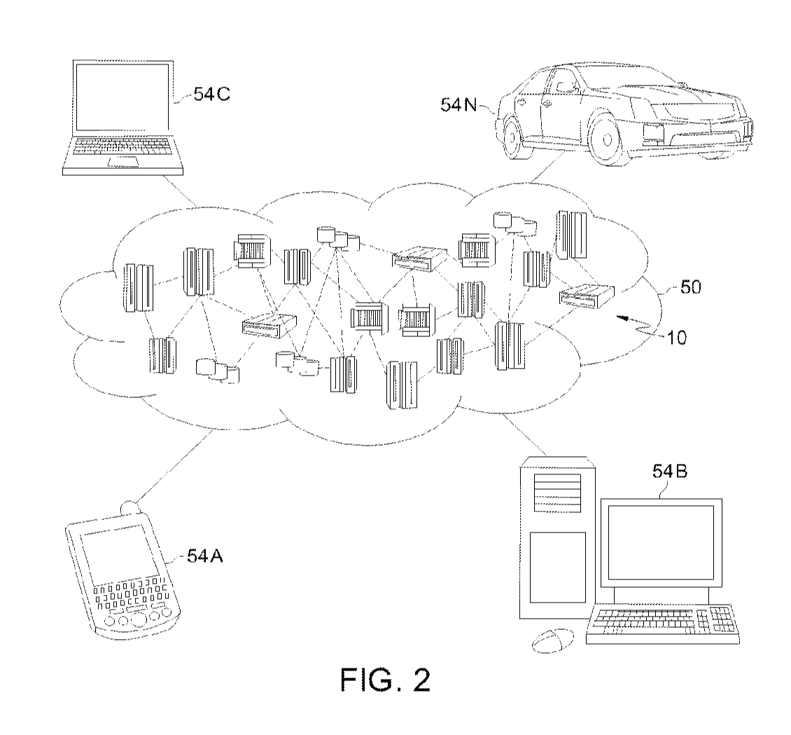

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

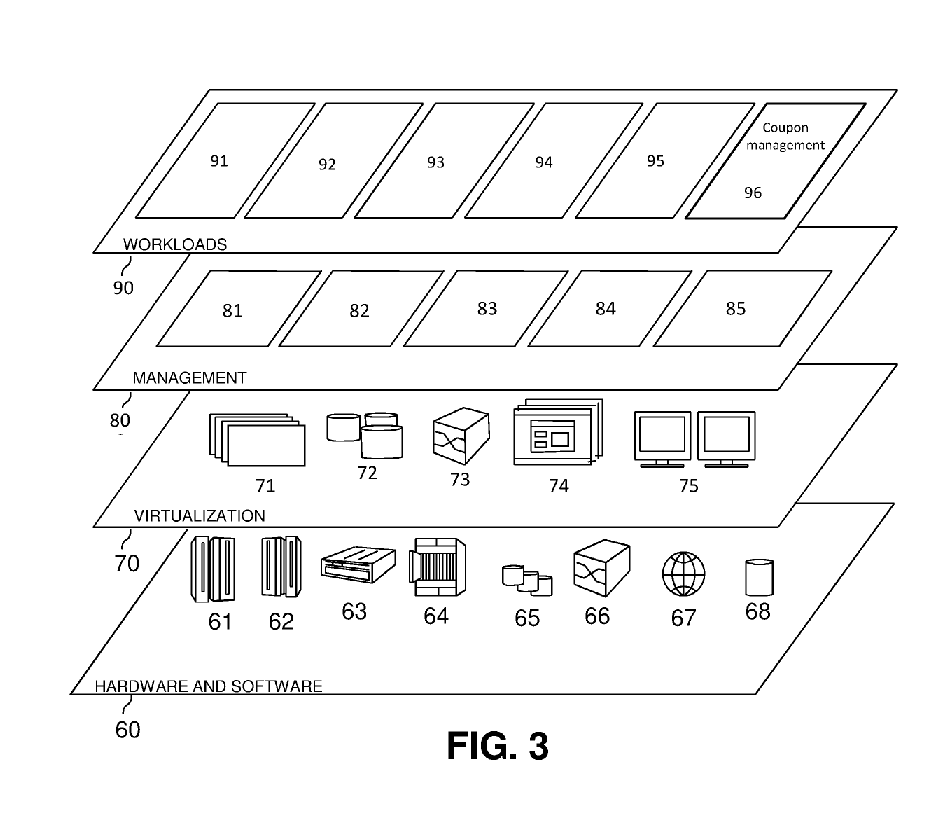

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and coupon management 96.

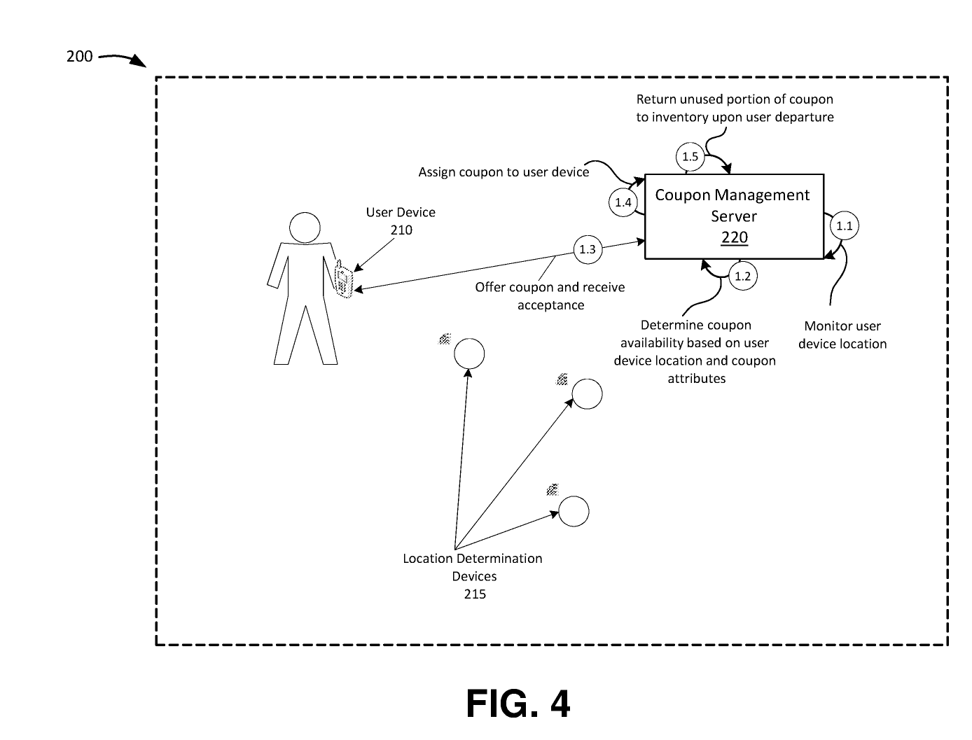

Referring back to FIG. 1, the program/utility 40 may include one or more program modules 42 that generally carry out the functions and/or methodologies of embodiments of the invention as described herein (e.g., such as the functionality provided by coupon management 96). Specifically, the program modules 42 may monitor user device location while located within a boundary (e.g., a merchant facility), detect the availability of a coupon based on the user device location and coupon attributes, offer the coupon to the user of the user device, assign the coupon to the user device, and update the coupon status, value, and assignment based on the coupon usage. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of a coupon management server as shown in FIG. 4.

FIG. 4 shows an overview of an example implementation in accordance with aspects of the present invention. As shown in FIG. 4, a coupon management server 220 may be implemented within a boundary 200 (e.g., a venue, a merchant facility, or the like). As a user with a user device 210 moves within the boundary 200, location determination devices 215 may be used to determine the location of the user device 210 while the user device 210 is located within the boundary 200. The coupon management server 220 may monitor user device location history within the boundary 200 using the location determination devices 215 (step 1.1). At step 1.2, the coupon management server 220 may determine coupon availability based on the user device location and coupon attributes. For example, the coupon attributes may include information regarding a product associated with the coupon, coupon location information (e.g., a location in the merchant facility for which the product is located), a current possessor of the coupon, or the like. In embodiments, the coupon management server 220 may determine coupon that a coupon is available when the user device location is within an area defined by the coupon location information and when the coupon is not currently in possession of (e.g., assigned to) another user device. Based on determining that the coupon is available, the coupon management server 220 may offer the coupon to the user device, and may receive an acceptance of the coupon from the user device (step 1.3). For example, the user device may display a notification indicating that the coupon is available. A user of the user device may provide user input to the user device to accept the coupon. Based on receiving the coupon acceptance, the coupon management server 220 may assign the coupon to the user (step 1.4). For example, the coupon management server 220 may assign the coupon to the user by updating a data structure to reflect that the coupon is now assigned to the user device. The user coupon management server 220 may track the coupon's usage and continue to monitor the user's location.

When the user departs from the boundary, the coupon management server 220 may return the unused portion of the coupon to a coupon inventory (step 1.5). For example, the coupon management server 220 may return the unused portion of the coupon by updating the data structure to reflect that the coupon is now assigned to the store inventory. Further, the coupon management server 220 may update the data structure to reflect that coupon's value after having been partially used. For example, if the coupon was originally for buying three items for 75 cents off, and the user partially redeemed the coupon to purchase only one item, the coupon's attributes may be updated to reflect that the coupon will now provide a discount of 50 cents on two items. In this way, the remaining portion of the coupon may be shared with other users when the coupon is not fully redeemed.

As described herein, aspects of the present invention provide a technical contribution of using a computer infrastructure (e.g., computer networks and location determination devices 215) to detect and track the location of user devices 210 within a facility, and in turn, automatically offer coupons to users via the detected user devices 210. Further, aspects of the present invention may track the chain of custody of coupons. The use of the computer infrastructure allows a merchant to manage, track, and offer coupons to a substantial number of users while allowing the users to share unused coupons upon their departure from the merchant facility. Further, the use of the computer infrastructure allows the merchant to manage, track, and offer coupons in a manner that would not be possible with human labor. In particular, the use of the particular computer infrastructure, as described herein, is leveraged in performing the processes of the invention and achieving the described benefits.

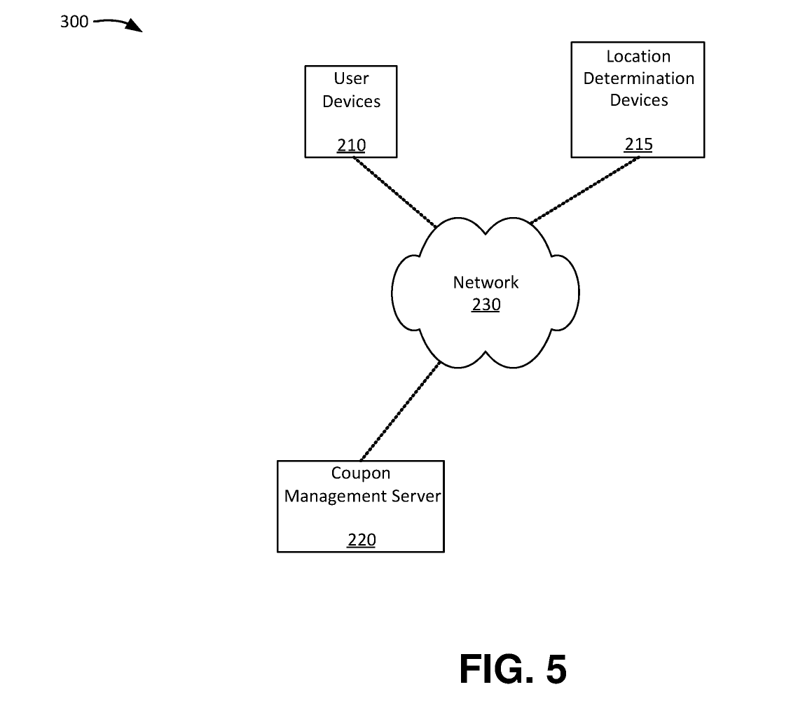

FIG. 5 shows an example environment in accordance with aspects of the present invention. As shown in FIG. 5, environment 300 may include user devices 210 (referred to individually as “user device 210” and collectively as “user devices 210”), location determination devices 215, coupon management server 220, and/or network 230. In embodiments, one or more components in environment 400 may correspond to one or more components in the cloud computing environment of FIG. 2.

The user devices 210 may each include a device capable of communicating via a network, such as the network 230. For example, the user devices 210 may each correspond to a mobile communication device (e.g., a smart phone or a personal digital assistant (PDA)), a portable computer device (e.g., a laptop or a tablet computer), or another type of computer device.

The location determination devices 215 may include one or more computing devices, such as beacons, network devices, or the like that may connect with the user device 210 via, for example, a wireless local area network (WLAN), a wireless personal area network (WPAN), or the like. Additionally, or alternatively, the location determination devices 215 may receive broadcast or discovery signals transmitted by the user device 210 without establishing a connection with the user device 210. The location determination devices 215 may provide information regarding the location of user devices 210 to the coupon management server 220. For example, each location determination device 215 may provide information regarding their own locations and signal strength information of a signal received from the user device 210. As described herein, the location determination device 215 may provide identification information for the user device 210 (e.g., a Media Access Control (MAC) address of the user device 210, a device identifier, or the like). The location determination devices 215 may be located in a particular location associated with a service provider or merchant that as part of a location-based coupon management and sharing system. Additionally, or alternatively, the location determination devices 215 may transmit signals that carry respective identifiers of the location determination devices 215. When a user device 210 is within communications range of a location determination device 215, the user device 210 may receive the identifier of the location determination device 215, and output the identifier to the coupon management server 220. The coupon management server 220 may then determine the location of the user device 210 based on the received identifier and the known location of the location determination device 215 associated with the identifier.

In embodiments, a merchant facility may implement one or more location determination devices 215 to determine the location of user devices 210 while the user devices 210 are located within the merchant facility (or a section within the merchant facility, such as a particular department of the merchant facility). The location determination devices 215 may be arranged such that communications range of the location determination devices 215 corresponds to a defined boundary (e.g., a boundary corresponding to a merchant facility or a boundary of a section of a merchant facility). In embodiments, communications blocking or shaping techniques may be used such that the communications range of the location determination devices 215 corresponds to a desired boundary. For example, wall papers, paints, and/or other techniques may be implemented within the merchant facility to prevent the communications range from exceeding a boundary. In this way, monitoring of user device 210 location may only occur while the user device 210 is located within the merchant facility.

The coupon management server 220 may include one or more computing devices (e.g., corresponding to server 12 of FIG. 1) that may manage electronic coupons for a venue or merchant. As described herein, the coupon management server 220 may monitor the location of user devices 210 located within a boundary (e.g., a merchant facility) by utilizing the location determination devices 215. In embodiments, the coupon management server 220 may further track the usage of coupons, the status/value of coupons, and/or the chain of custody of coupons (e.g., a possessor of the coupons). The coupon management server 220 may offer coupons to a user device 210 based on the coupon's attributes (e.g., merchandise location associated with the coupon) and the location of the user device 210.

The network 230 may include network nodes, such as network nodes 10 of FIG. 2. Additionally, or alternatively, the network 230 may include one or more wired and/or wireless networks. For example, the network 230 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 230 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in the environment 300 is not limited to what is shown in FIG. 5. In practice, the environment 300 may include additional devices and/or networks; fewer devices and/or networks; different devices and/or networks; or differently arranged devices and/or networks than illustrated in FIG. 5. Also, in some implementations, one or more of the devices of the environment 300 may perform one or more functions described as being performed by another one or more of the devices of the environment 2300. Devices of the environment 300 may interconnect via wired connections, wireless connections, or a combination of wired and wireless connections.

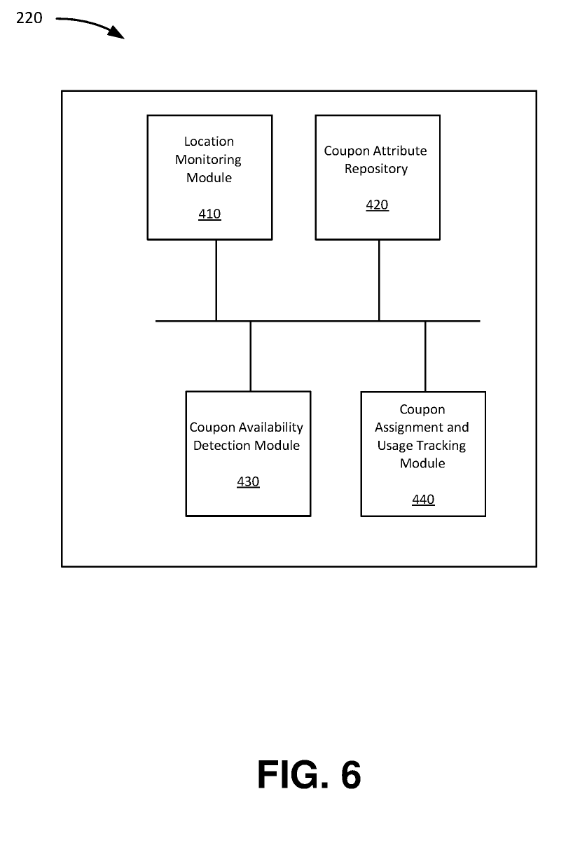

FIG. 6 shows a block diagram of example components of a coupon management server 220 in accordance with aspects of the present invention. As shown in FIG. 6, the coupon management server 220 may include a location monitoring module 410, a coupon attribute repository 420, a coupon availability detection module 430, and a coupon assignment and usage tracking module 440. In embodiments, the coupon management server 220 may include additional or fewer components than those shown in FIG. 6. In embodiments, separate components may be integrated into a single computing component or module. Additionally, or alternatively, a single component may be implemented as multiple computing components or modules.

The location monitoring module 410 may include a program module (e.g., program module 42 of FIG. 1) that monitors the location of user devices 210 within a boundary (e.g., a merchant facility). For example, the location monitoring module 410 may monitor the location of the user devices 210 using data from the location determination devices 215.

The coupon attribute repository 420 may include a data storage device (e.g., storage system 34 of FIG. 1) that stores information regarding coupon attributes. For example, for a particular coupon, the coupon attribute repository 420 may store a data structure with attribute information indicating merchandise associated with the coupon, a location associated with the coupon (e.g., a location of the merchandise in a merchant facility) a discount amount per unit, a current possessor of the coupon, a value of the coupon, etc. As described herein, the attributes of the coupon may be modified as the coupon is reassigned and redeemed.

The coupon availability detection module 430 may include a program module (e.g., program module 42 of FIG. 1) that detects the availability of a coupon to be offered to a user based on the location of a user device 210 and the attributes of the coupon (e.g., the coupon location and the coupon possessor). As described herein, the coupon availability detection module 430 may determine that the coupon is available when the user device 210 is located in the coupon location and when the coupon is currently in possession by (e.g., assigned to) an inventory of the merchant (e.g., not in possession by another user device 210). Based on detecting that the coupon is available, the coupon availability detection module 430 may provide a message to the user device 210 to offer the coupon to the user device 210.

The coupon assignment and usage tracking module 440 may include a program module (e.g., program module 42 of FIG. 1) that assigns a coupon to a user device 210 (e.g., when the user device 210 provides a message to accept an offer for the coupon). For example, the coupon assignment and usage tracking module 440 may assign the coupon by modifying information stored by the coupon attribute repository 420 to reflect that the possession of the coupon has been changed to the user device 210. More specifically, the coupon assignment and usage tracking module 440 may modify a field in a data structure of the coupon to reflect an identifier of the user device 210 to which the coupon has been assigned.

In embodiments, the coupon assignment and usage tracking module 440 may track the usage of the coupon. For example, the coupon assignment and usage tracking module 440 may receive information from a merchandise check-out system that indicates when the coupon has been redeemed and an amount for which the coupon has been redeemed. For example, if the coupon offers a discount of 75 cents on a quantity of three items, and one item has been redeemed, the coupon assignment and usage tracking module 440 may determine that the a discount of 50 cents for two items remains on the coupon. The coupon assignment and usage tracking module 440 may update the attributes in the coupon repository accordingly as the coupon is redeemed. When the coupon is fully redeemed, the coupon assignment and usage tracking module 440 may direct the coupon attribute repository 420 to delete the coupon entirely.

In embodiments, the coupon assignment and usage tracking module 440 may communicate with the location monitoring module 410 to determine when a user device 210 to which a coupon is currently assigned departs from a merchant facility. The coupon assignment and usage tracking module 440 may update the coupon attributes to modify the possessor from the departed user device 210 back to the merchant inventory. In embodiments, the coupon assignment and usage tracking module 440 may modify a code corresponding to the coupon when the user device 210 departs the merchant facility (e.g., for coupons stored locally in the user device 210). For example, the coupon assignment and usage tracking module 440 may modify a code corresponding to the coupon so that the coupon locally stored by a departed user device 210 may no longer be valid. In this way, unused coupons (or unused portions of coupons) may later be offered to other users.

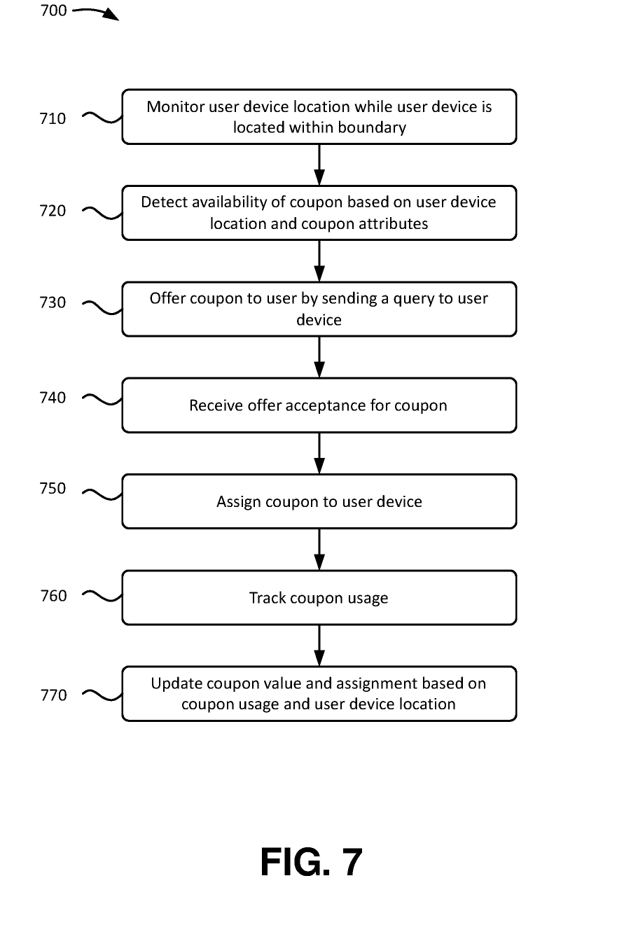

FIG. 7 shows an example flowchart for offering an available coupon to a user and sharing unused portions of the coupon to other users. The steps of FIG. 7 may be implemented in the environment of FIG. 4, for example, and are described using reference numbers of elements depicted in FIG. 4. As noted above, the flowchart illustrates the architecture, functionality, and operation of possible implementations of systems, methods, and computer program products according to various embodiments of the present invention.

As shown in FIG. 7, process 700 may include monitoring user device location while the user device is located within a boundary (step 710). For example, as described above with respect to the location monitoring module 410, the coupon management server 220 may monitor the location of the user devices 210 using the location determination devices 215.

Process 700 may further include detecting the availability of a coupon based on user device location and coupon attributes (step 720). For example, as described above with respect to the coupon availability detection module 430, the coupon management server 220 may detects the availability of a coupon to be offered to a user based on the location of a user device 210 and the attributes of the coupon (e.g., the coupon location and the coupon possessor). As described herein, the coupon availability detection module 430 may determine that the coupon is available when the user device 210 is located in the coupon location and when the coupon is currently in possession by (e.g., assigned to) an inventory of the merchant (e.g., not in possession by another user device 210).

Process 700 may also include offering the coupon to a user by sending a query to the user device (step 730). For example, as described above with respect to the coupon availability detection module 430, the coupon management server 220 may provide a message (e.g., with a query) to the user device 210 to offer the coupon to the user device 210 based on detecting that the coupon is available, the coupon management server 220. Based on receiving the message, the user device 210 may display the message as a notification and the user of the user device 210 may respond via user input to accept or deny the offered coupon.

Process 700 may further include receiving an offer acceptance for the coupon (step 740) and assigning the coupon to the user device (step 750). For example, as described above with respect to the coupon assignment and usage tracking module 440, the coupon management server 220 may receive an offer acceptance for the coupon from the user device 210. Further, the coupon management server 220 may assign the coupon by modifying information stored by the coupon attribute repository 420 to reflect that the possession of the coupon has been changed to the user device 210. Additionally, or alternatively, the coupon management server 220 may assign the coupon by adding an identifier of the coupon to a profile associated with the user device 210.

Process 700 may also include tracking the coupon's usage (step 760). For example, as described above with respect to the coupon assignment and usage tracking module 440, the coupon management server 220 may track the usage of the coupon (e.g., by communicating with a merchant checkout system that notifies the coupon management server 220 when the coupon has been redeemed).

Process 700 may further include updating the coupon value and assignment based on coupon usage and user device location (step 770). For example, as described above with respect to the coupon assignment and usage tracking module 440, the coupon management server 220 may update the coupon value based on the usage of the coupon (e.g., by tracking the coupon as described above). Further, the coupon management server 220 may update the coupon discount quantity based on the usage. As described herein, the coupon management server 220 may update the coupon assignment based on detecting that the user device 210 has departed the merchant facility. For example, the coupon management server 220 may update the coupon assignment from the user device 210 back to the merchant coupon inventory when the user device 210 has departed the merchant facility. Additionally, or alternatively, the coupon management server 220 may update the coupon assignment when the user device 210 has departed from a section of the merchant facility for a threshold period of time (e.g., to allow the coupon to be returned to the merchant coupon inventory sooner than when the user departs the merchant facility). In this way, coupons may be shared with other users when the coupon has not been fully used.

In embodiments, the value for a coupon may be split and applied to user accounts once the coupon has been fully redeemed. For example, if a first user partially redeems a coupon offering 75 cents discount of a quantity of three items by purchasing one item and a second user partially redeems the coupon by purchasing two items, the first user may receive a refund of 25 cents and the second user may receive refund of 50 cents once the coupon has been fully redeemed. Alternatively, each user may receive a discount or refund at the time of purchase based on the portion of the coupon redeemed.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
monitoring, by a computing device, a location of a user device by communicating with one or more location determination devices that are used to determine the location of the user device through computing network communications with the user device, wherein the one or more location determination devices comprise at least one selected from a group consisting of:
a beacon,
a wireless router, and
a wireless personal area network device,
the one or more location determination devices determining the location of the user device based on receiving discovery signals from the user device or establishing a connection with the user device;
detecting, by the computing device, the availability of an electronic coupon stored in an inventory based on the location of the user device and a location associated with the electronic coupon;
offering, by the computing device, the electronic coupon to the user device based on the detecting the availability by providing an electronic query to the user device for display on the user device;
assigning, by the computing device, the electronic coupon to the user device based on the offering the electronic coupon to the user device;
detecting, by the computing device, that the user device departs a boundary based on the monitoring the location; and
assigning, by the computing device, an unused portion of the electronic coupon to the inventory based on the detecting that the user device departs the boundary, wherein the unused portion of the electronic coupon includes a partial value of an original value of the electronic coupon.

2. The method of claim 1, further comprising assigning the unused portion of the electronic coupon to another user device.

3. The method of claim 1, further comprising:
tracking the usage of the electronic coupon; and
updating a value of the electronic coupon based on tracking the usage of the electronic coupon, wherein the unused portion of the electronic coupon corresponds to the updated value of the electronic coupon.

4. The method of claim 1, further comprising receiving an acceptance to the offer from the user device, wherein the assigning the electronic coupon is based on receiving the acceptance to the offer.

5. The method of claim 1, wherein the assigning the electronic coupon to the user device includes modifying a field in a data structure associated with the electronic coupon indicating that the electronic coupon possessed by the user device.

6. The method of claim 5, wherein the assigning the unused portion of the electronic coupon to the inventory includes modifying the field in the data structure associated with the electronic coupon indicating that the electronic coupon is in possession of the inventory.

7. The method of claim 1, wherein the assigning the unused portion of the electronic coupon to the inventory includes invalidating a code associated with the electronic coupon and generating a new code for the electronic coupon.

8. The method of claim 1, wherein the assigning the electronic coupon to the user device includes adding an identifier of the electronic coupon to a profile of the user device.

9. (canceled)

10. The method of claim 1, wherein a service provider at least one of creates, maintains, deploys and supports the computing device.

11. The method of claim 1, wherein steps of claim 1 are provided by a service provider on a subscription, advertising, and/or fee basis.

12. The method of claim 1, wherein the computing device includes software provided as a service in a cloud environment.

13. The method of claim 1, further comprising deploying a system for sharing unused or partially used electronic coupons when a user departs a facility, comprising providing a computer infrastructure operable to perform the steps of claim 1.

14. A computer program product for sharing unused or partially used electronic coupons when a user departs a facility, the computer program product comprising a computer readable storage medium having program instructions embodied therewith, the program instructions executable by a computing device to cause the computing device to:
monitor a location of a user device while the user device is located within the facility, wherein the monitoring includes communicating with one or more location determination devices that are used to determine the location of the user device through computing network communications with the user device, wherein the one or more location determination devices comprise at least one selected from a group consisting of:
a beacon,
a wireless router, and
a wireless personal area network device,
the one or more location determination devices determining the location of the user device based on receiving discovery signals from the user device or establishing a connection with the user device;
detect availability of an electronic coupon stored in an inventory based on the location of the user device and a location associated with the electronic coupon;
offer the electronic coupon to the user device based on the detecting the availability by providing an electronic query to the user device for display on the user device;
assign the electronic coupon to the user device based on the offering the electronic coupon to the user device;
detect that the user device departs the facility based on the monitoring the location; and
assign an unused portion of the electronic coupon to the inventory based on the detecting that the user device departs the boundary, wherein the unused portion of the electronic coupon includes a partial value of an original value of the coupon.

15. The computer program product of claim 14, wherein the program instructions further cause the computing device to assign the unused portion of the electronic coupon to another user device after assigning the unused portion to the inventory.

16. The computer program product of claim 14, wherein the assigning the electronic coupon to the user device includes modifying a field in a data structure associated with the electronic coupon indicating that the electronic coupon is in possession of the user device.

17. The computer program product of claim 16, wherein the assigning the unused portion of the electronic coupon to the inventory includes modifying the field in the data structure associated with the electronic coupon indicating that the electronic coupon is in possession of the inventory.

18. (canceled)

19. A system comprising:
a CPU, a computer readable memory and a computer readable storage medium associated with a computing device;
program instructions to monitor a location of a user device while the user device is located within the facility, wherein the monitoring includes communicating with one or more location determination devices that are used to determine the location of the user device through computing network communications with the user device, wherein the one or more location determination devices comprise at least one selected from a group consisting of:
a beacon,
a wireless router, and
a wireless personal area network device,
the one or more location determination devices determining the location of the user device based on receiving discovery signals from the user device or establishing a connection with the user device;
program instructions to assign an electronic coupon to the user device;
program instructions to track a usage of the electronic coupon based on assigning the electronic coupon;
program instructions to determine that the user device has departed the facility based on the monitoring the location of the user device; and
program instructions to reassign an unused portion of the electronic coupon to another user device based on determining that the user device has departed the facility, wherein the unused portion of the electronic coupon includes a partial value of an original value of the coupon,
wherein the program instructions are stored on the computer readable storage medium for execution by the CPU via the computer readable memory.

20. The system of claim 19, further comprising program instructions to update a value of the coupon before reassigning the electronic coupon to the other user device.

21. The method of claim 1, further comprising:
receiving a response to the query via a user interface of the user device, wherein the response indicates whether the coupon should be assigned to the user device, wherein the assigning the electronic coupon to the user device is based receiving the response indicating that the coupon should be assigned to the user device; and
retaining the coupon in the inventory based receiving the response indicating that the coupon should not be assigned to the user device.

22. The method of claim 21, wherein the unused portion is a non-zero value.
